(19) United States
(12) Patent Application Publication
(10) Pub. No.: US 2026/0128975 A1
(43) Pub. Date: May 7, 2026

(54) Device and Method for Dynamically Updating Timeout Values

(71) Applicant: Zebra Technologies Corporation, Lincolnshire, IL (US)

(72) Inventors: Anandakumar Gopalsamy, Ronkonkonma, NY (US); Ohad Shatil, Dunwoody, GA (US); Dayal Madhukar Rai, Bangalore (IN); Ambika Nagarajaiah, Bangalore (IN)

(73) Assignee: Zebra Technologies Corporation, Lincolnshire, IL (US)

(21) Appl. No.: 18/939,293

(22) Filed: Nov. 6, 2024

(51) Int. Cl. H04L 43/0864; H04L 43/55

(52) U.S. Cl. CPC H04L 43/0864; H04L 43/55

(57) ABSTRACT

An example method includes: setting a timeout value for retrying communication requests during a communications session with a target device; sending a test request to the target device; measuring a response time between the test request and a response to the test request received from the target device; determining a specific timeout value for the target device based on the response time; and updating the timeout value with the specific timeout value for the target device and continuing the communications session with the specific timeout value for retrying communication requests for the target device.

### BACKGROUND

During wireless communications, various network and endpoint device conditions may cause variations in the speed of communications. In some cases, the communications link between two endpoint devices may be experience an issue requiring a recovery operation to recover. Prior to initiating the recovery operation, the devices may wait for a default timeout period to elapse to ensure that communications are not simply slow. The default timeout period may be set to be sufficiently long to cover such slow communications due to the network and endpoint device conditions. However, such a long default timeout period results in delayed recovery operations and may result in dropped packets or communications.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a schematic diagram of an example system for dynamically updating timeout values.

FIG. 2 is a block diagram of certain internal components of the device for dynamically updating timeout values of FIG. 1.

FIG. 3 is a flowchart of an example method of dynamically updating timeout values.

FIG. 4 is a flowchart of an example method of determining a specific timeout value at block 340 of the method of FIG. 3.

FIG. 5 is a schematic diagram of an example flow of communications with dynamically updated timeout values.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method comprising: setting a timeout value for retrying communication requests during a communications session with a target device; sending a test request to the target device; measuring a response time between the test request and a response to the test request received from the target device; determining a specific timeout value for the target device based on the response time; and updating the timeout value with the specific timeout value for the target device and continuing the communications session with the specific timeout value for retrying communication requests for the target device.

Additional examples disclosed herein are directed to a device comprising: a communications interface configured for communications with a target device; a controller interconnected with the communications interface, the controller configured to: set a timeout value for retrying communication requests during the communications with the target device; send a test request to the target device; measure a response time between the test request and a response to the test request received from the target device; determine a specific timeout value for the target device based on the response time; and update the timeout value with the specific timeout value for the target device and continue the communications with the specific timeout value for retrying communication requests for the target device.

Further examples disclosed herein are directed to a non-transitory machine-readable storage medium storing instructions, which when executed by a computing device cause the computing device to: set a timeout value for retrying communication requests during a communications session with a target device; send a test request to the target device; measure a response time between the test request and a response to the test request received from the target device; determine a specific timeout value for the target device based on the response time; and update the timeout value with the specific timeout value for the target device and continue the communications with the specific timeout value for retrying communication requests for the target device.

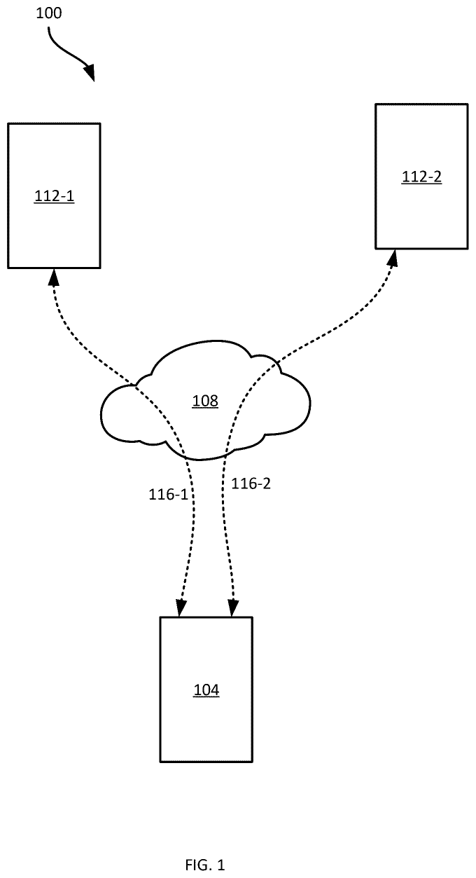

FIG. 1 depicts a system 100 for dynamically updating timeout values in accordance with the teachings of this disclosure. The system 100 includes a computing device 104 (also referred to herein as simply the device 104) connected to a network 108 for communications with one or more target devices, of which two example target devices 112-1 and 112-2 are depicted (referred to herein generically as a target device 112 and collectively as the target devices 112; this nomenclature is also used elsewhere herein).

The devices 104 and 112 may be a mobile computing devices such as handheld computers, mobile phones, tablets, barcode scanners or the like. In other examples, the devices 104 and 112 may be fixed computing devices, such as desktop computers, servers, kiosks, or the like. The device 104 may be in communication with the target devices 112 via respective communication links 116-1 and 116-2. The communication links 116 are illustrated in the present example as including wireless links. In particular, the communication links 116 traverse the network 108, which may be a wireless local area network (WLAN) and/or a wireless wide area network (WWAN), such as the Internet, mobile networks, or other suitable wireless network deployed by one or more base stations, access points or the like. In some examples, the communication links 116 may include wired connections, or traverse combinations of networks 108, and may include combinations of wired and wireless connections.

During a communications session between the computing device 104 and one of the target devices 112, the device 104 and the target device 112 may exchange communication requests and responses. Due to the nature of network communications, there may sometimes be delays or failures in the communications request or response, for example due to issues between the device 104 and the network 108, within the network 108 itself, or between the network 108 and the target device 112. To manage potential failures and facilitate ongoing communications during the communications session, the device 104 may store a timeout value defining waiting period for a response to a given communications request. After the timeout, the device 104 may retry the communications request, and after a predefined number of retries, the device 104 may determine that the connection over the communication link 116 is lost, and may initiate a recovery operation to recover the link 116 to the target device 112.

However, the timeout values are often based on predefined default values, and hence may be longer or shorter than a suitable timeout value based on an expected communication time to the target device. When the timeout value is longer than optimal (i.e., longer than can be reasonably expected to receive a response from the target device 112), the device 104 may delay retrying the communications request and initiating the recovery operation when the target device 112 is not responding. When the timeout value is shorter than optimal (i.e., shorter than can be reasonably expected to receive a response from the target device 112), the device 104 may initiate retries and recovery operations unnecessarily, resulting in wasted resources.

Thus, in accordance with the present disclosure, the device 104 may employ test requests used to measure individual response times to each target device 112 and dynamically update the timeout values associated with each target device 112. The device 104 may further apply a buffer and a complexity weighting to a base timeout value to achieve specific timeout values for each target device 112 and for different parameters of a given communications request (e.g., based on the protocol of the communications request or similar). For example, the device 104 may initiate a series of test requests with the different parameters, such as different protocols, different priority markings, or the like. The base timeout value may be individually associated with the different parameters for communications with the given target device 112, or the device 104 may select a slowest response time to ensure coverage for most types of communications with the given target device 112.

For example, different protocols may have different complexities and/or communications with different target devices 112 may occur over different networks or combination of networks, resulting in different network conditions. Accordingly, the communication time to the first target device 112-1 may be shorter than the communication time to the second target device 112-2. Thus, based on the respective test requests and corresponding response times, the device 104 may set a higher specific timeout value for the target device 112-2 than the specific timeout value for the target device 112-1.

The device 104 may also be configured to dynamically update the timeout values based on certain update conditions. For example, the update condition may be the passage of a predetermined amount of time, or upon detecting certain network conditions (e.g., changing quality of service factors such as jitter, latency, dropped packets, or the like). The timeout values may therefore be updated to accommodate varying network conditions or the like.

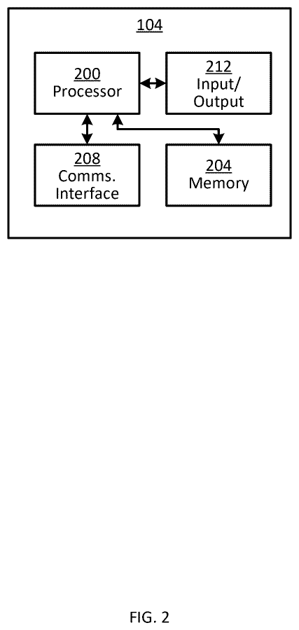

Turning now to FIG. 2, certain internal components of the computing device 104 are illustrated. The device 104 includes a processor 200 interconnected with a non-transitory computer-readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 may each comprise one or more integrated circuits. The memory 204 stores computer-readable instructions for execution by the processor 200, including one or more applications which, when executed, configure the processor 200 to perform the various functions of the device 104.

The device 104 further includes a communications interface 208 enabling the device 104 to exchange data with other computing devices, such as the target devices 112. The communications interface 208 is interconnected with the processor 200. The communications interface 208 may include a controller, and one or more antennas, transmitters, receivers, or the like (not shown), to allow the device 104 to communicate with other computing devices such as the target devices 112 over the network 108 via the link 116. The communications interface 208 may further allow the device 104 to communicate with (e.g., to broadcast signals, via a two-way communication link, etc.) other computing devices according to other communications protocols, such as a Bluetooth Low Energy protocol or other suitable wireless transmission protocol.

For example, the controller may be a micro-controller, a micro-processor, or other suitable device capable of executing computer-readable instructions to control the components, such as the antennae, transmitters, receivers, and the like, of the communications interface 208 to perform the functionality described herein. The controller may comprise one or more integrated circuits and may include and/or be interconnected with a non-transitory computer-readable storage medium storing computer-readable instructions which when executed configure the controller and/or the communications interface 208 to perform the functionality described herein. In particular, the controller may control a dynamic update of timeout values of the device 104. For example, the controller may cooperate with a cache or integrated memory, or the memory 204 to set and store timeout values for retrying a communications request. The timeout values may be dynamically updated, as described herein, and may be associated with a particular target device, a communications protocol, a priority marking, or combinations of the above and other parameters.

The device 104 may further include one or more input and/or output devices 212 suitable to allow an operator to interact with the device 104. The input devices may include one or more buttons, keypads, touch-sensitive display screens or the like for receiving input from an operator. The output devices may further include one or more display screens, sound generators, vibrators, or the like for providing output or feedback to an operator.

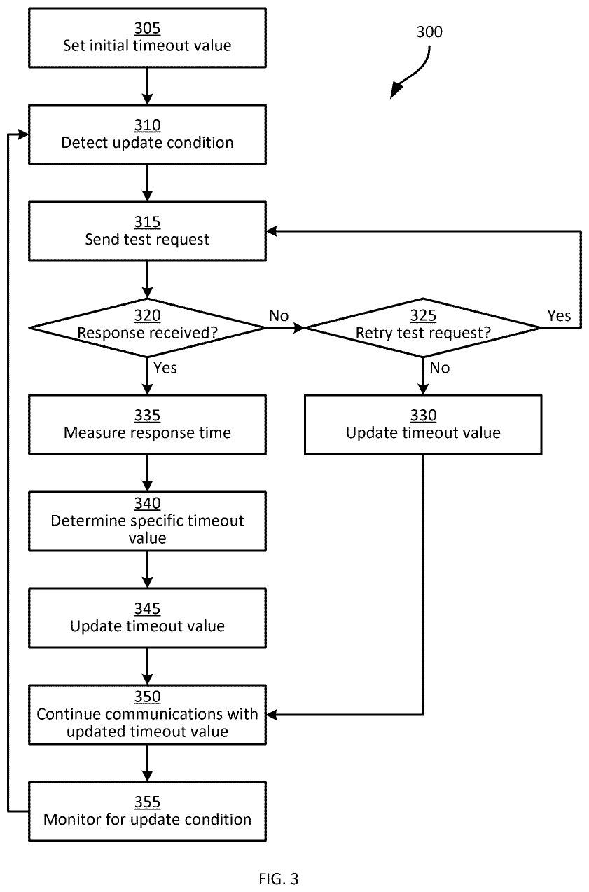

Turning now to FIG. 3, the functionality implemented by the device 104 will be discussed in greater detail. FIG. 3 illustrates a method 300 of dynamically updating a timeout value for retrying communications requests. The method 300 will be discussed in conjunction with its performance in the system 100, and particularly by the device 104. In particular, the method 300 will be described with reference to the components of FIGS. 1 and 2. In other examples, the method 300 may be performed by other suitable devices or systems.

The method 300 is initiated at block 305, for example in response to initialization of a communications session between the device 104 and one of the target devices 112. At block 305, the device 104 is configured to set an initial timeout value for the communications session with the target device 112.

In particular, the initial timeout value defines a length of a timeout period after sending a communications request to the target device 112 before retrying or initiating a recovery operation for the link 116 to the target device 112. When the communications is newly initialized, the initial timeout value may be a predefined default timeout value, such as 200 ms, 500 ms, or other suitable values, which may vary based on the type of communication protocol used for the communications session, or other parameters.

At block 310, the device 104 is configured to detect an update condition for updating the timeout value for a communications session with one of the target devices 112. For example, the update condition may be the initialization of the communications session with the target device 112. In subsequent iterations of the method 300, as will be described further below, the update condition may be passage of a predetermined update period, detection of certain network conditions associated with the network 108 (e.g., based on a quality of service, including latency, jitter, or other suitable parameters), or the like.

At block 315, the device 104 is configured to send a test request to the target device 112. The test request may be an ARP request, a DHCP request, a ping request, or request via another suitable communications protocol. For example, the test request may be marked with predefined header and/or packet values, flags, or the like. In particular, the test request is configured as a supplementary request external to the regular communications requests and responses used during the communications session to support, for example a voice call or other communications. The device 104 may initiate a timer with the sending of the test request to subsequently measure a response time of a response to the test request.

In some examples, the device 104 may send a suite or series of test requests to the target device 112. For example, each test request in the series may be configured with different parameters, such as different protocols, different priority markings, or other relevant factors which may affect the response time to the test request. In particular, with respect to the priority markings, the device 104 may send a first test request which is marked with a priority for processing the test request by the target device 112. Since the response time of the response to the test request is used to determine a timeout value (i.e., a time after which a response is unlikely), the device 104 may mark the first test request with a lowest priority value. The target device 112 may therefore process the first test request with lowest relative priority, and hence the response time for the response to the first test request represents a slowest expected response from the target device 112.

The device 104 may additionally send a second test request which is unmarked. That is, in some communications protocols, or in certain situations, the device 104 may be unable to define the priority marking of the requests sent. Rather, the priority level may be determined and set by the network 108 itself. Accordingly, the response time associated with the second test request may represent variability in prioritization and management of the communications requests and responses within the network 108 itself.

In other examples, other test requests varying other parameters of the request may also be sent. In still further examples, multiple test requests having the same parameters may be sent, for example to account for variability of network speed and processing for a given set of parameters.

At block 320, the device 104 is configured to determine whether a response to the test request sent at block 315 has been received. The device 104 may make the determination at block 320 after a test timeout period has elapsed. The test timeout period may be equal to the current timeout value for the target device 112. For example, at a first iteration of the method 300, the test timeout period may be the default timeout value. In subsequent iterations of the method 300, the test timeout period may be the determined timeout value for the device 112. In other examples, the test timeout period may be longer than the current timeout value, for example to account for the case when the default timeout value is shorter than optimal, or for changes in network conditions which result in a longer expected response time, or the like. Thus, the test timeout period may be a predefined value (e.g., the default timeout value plus a buffer), or an extension of the current timeout value, for example with a buffer or a multiplier applied, or the like.

If the determination at block 320 is negative, that is, no response has been received within the test timeout period, then the device 104 proceeds to block 325. At block 325, the device 104 is configured to determine whether to retry the test request. For example, the device 104 may similarly iterate through a threshold number of test requests before determining a connectivity issue.

If the determination at block 325 is affirmative, that is, retrying the test request is warranted, then the device 104 returns to block 315 to send another test request.

If the determination at block 325 is negative, that is, no retry of the test request is warranted, then the device 104 may proceed to block 330 to update the timeout value for the target device 112. For example, since the device 104 may determine that there is a connectivity issue with the target device 112, the device 104 may reset the timeout value for the target device 112 to the predefined default timeout value. In other examples, the device 104 may modify the current timeout value by a multiplier or buffer (e.g., to extend the current timeout value). The device 104 may then proceed to block 350 to continue communications with the target device 112 with the updated timeout value.

If the determination at block 320 is affirmative, that is, a response to the test request sent at block 315 was received, then the device 104 proceeds to block 335. At block 335, the device 104 measures the response time between the response and the test request. For example, the device 104 may use the timer initiated at the sending of the test request at block 315.

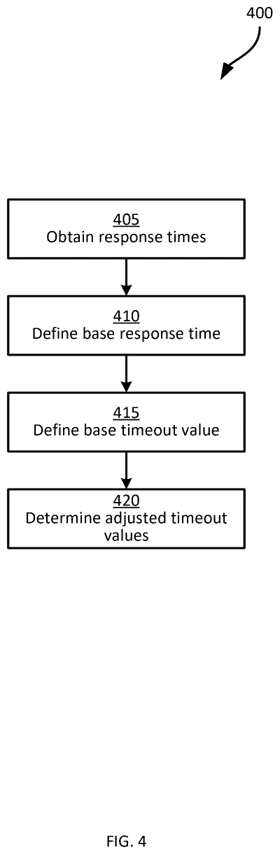

At block 340, the device 104 is configured to determine a specific timeout value for the target device 112 to which the test request was sent. For example, referring to FIG. 4, a flowchart of an example method 400 of determining a specific timeout value is depicted.

At block 405, the device 104 is configured to obtain respective response times from each of the test requests. For example, the device 104 may obtain the respective response times for the first test request marked with the lowest priority value, as well as for the second test request unmarked with a priority value.

At block 410, the device 104 is configured to select or define a base response time based on the one or more response times obtained at block 405. For example, the device 104 may select the longest response time, such that the base response time covers the response time for each type of test request (i.e., each test request with different parameters) sent by the device 104 to the target device 112. In other examples, the device 104 may define the base response time to be a mean or average response time or another suitable computation. In still further examples, the device 104 may define a base response time associated with each of the test requests, according to the differing parameters of the test requests, such as communications protocol, priority marking and the like.

At block 415, the device 104 is configured to add a buffer time to the base response time defined at block 410 to obtain a base timeout value. The buffer time may be a predefined time period (e.g., 100 ms, 200 ms, etc.) to account for normal variances in packet transmissions and communication. In some examples, the buffer time may vary based on the communications protocol or other parameters.

At block 420, the device 104 is configured to define an adjusted timeout value associated with specific parameters. For example, the device 104 may define adjusted timeout values for each communications protocol that the device 104 may employ. The adjusted timeout values may be determined by applying a modifier or weighting, such as a multiplicative factor, to the base timeout value determined at block 415. For example, the modifier or weighting may represent the complexity of each communications protocol. That is, since the communications to a given target device 112 under different communications protocols may utilize the same underlying structures and framework of the network 108, communications over the same path may encounter the same network conditions. Accordingly, variances in response speed may vary largely due to the complexity of the communications protocol being employed, and the timeout values may be modified accordingly to reflect the differences in expected response time based on the communications protocol.

Returning now to FIG. 3, at block 345 the device 104 is configured to update the timeout value for the selected target device 112 based on the determined timeout value(s) from block 340. In particular, the device 104 may save the timeout values in the memory 204 in association with the parameters for which the timeout value is defined.

At block 350, the device 104 is configured to continue the communications session with the target device 112 in accordance with the updated timeout value. That is, the updated timeout value represents an adjusted or updated time period that the device 104 waits until the device 104 commences a retry or recovery operation. In particular, since the updated timeout value is determined based on current network conditions and near real-time communications speeds with the target device 112, communications using the updated timeout value may be enabled with reduced waiting time before initiating the retry and recovery operations, and/or reduced amount of unnecessary retry and recovery operations.

At block 355, the device 104 continues to monitor for update conditions. For example, the device 104 may have a predefined update period to periodically update the timeout values. For example, the predefined update period may be every minute, every 5 minutes, every half hour, etc. Additionally or alternatively, the device 104 may monitor the network 108 for changing network conditions. For example, the device 104 may monitor quality of service parameters, such as jitter, latency, dropped packets, and the like. Upon detecting a threshold change in the quality of service parameters, the device 104 may identify an update condition. Other update conditions are also contemplated. Upon detecting the update condition, the device 104 may return to block 310.

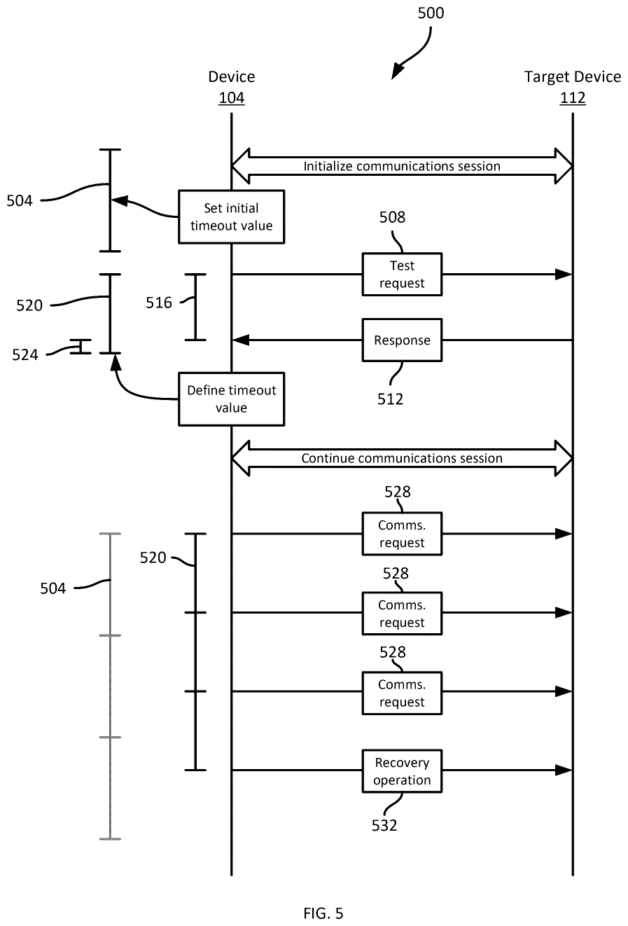

FIG. 5 depicts a schematic diagram of an example communications flow 500 in accordance with the present disclosure. In particular, a communications session may first be initialized between the device 104 and the target device 112. The device 104 may then set an initial timeout value 504, for example corresponding to a predefined default timeout value. Upon initialization of the communications session, the device 104 may detect an update condition and may send a test request 508 to the target device 112 and receive a response 512.

The device 104 may measure the response time 516 between the test request 508 and the response 512 and use the response time 516 to define a timeout value 520 for the target device 112. For example, the timeout value 520 may be an aggregation of the response time 516 and a buffer time 524. In other examples, as described above, the device 104 may send multiple test requests 508 having different parameters and receive multiple responses 512. The device 104 may then use a slowest response time 516 and add the buffer time 524 to obtain the timeout value 520. In some examples, the device 104 may additional adjust the timeout value 520 by a complexity factor or the like.

After defining the timeout value, the device 104 may continue the communications session with the target device 112 with the dynamically updated timeout value 520 used for retrying failed communications requests and subsequently initiating recovery operations. For example, during the communications session, the device 104 may initiate a communications request 528. If the device 104 does not receive a response within the period defined by the updated timeout value 520, then the device 104 may retry sending the communications request 528, for example up to three times. Upon expiry of the third period defined by the updated timeout value 520, the device 104 may initiate a recovery operation 532 to recover the communications session with the target device 112.

Since the timeout value 520 is defined based on an actual response time 516 and includes the buffer time 524, the device 104 may reasonably expect that the lack of response to the communications request 528 within the timeout period 520 indicates a delivery issue. Accordingly, the device 104 need not wait out the entire predefined default timeout period 504 before subsequently retrying the communications request 528. Further, the overall time before identifying an issue and initiating the recovery operation 532 may be shortened and therefore may reduce disconnect times and dropped packets within the communications session.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
setting a timeout value for retrying communication requests during a communications session with a target device;
sending a test request to the target device;
measuring a response time between the test request and a response to the test request received from the target device;
determining a specific timeout value for the target device based on the response time; and
updating the timeout value with the specific timeout value for the target device and continuing the communications session with the specific timeout value configured for retrying communication requests for the target device.

2. The method of claim 1, wherein sending the test request comprises:
sending a plurality of test requests and receiving a plurality of responses at respective response times; and
selecting a slowest response time of the respective response times for determining the specific timeout value.

3. The method of claim 2, wherein each test request of the plurality of test requests includes different parameters.

4. The method of claim 3, wherein the different parameters comprise a marked priority level and an unmarked priority level.

5. The method of claim 3, wherein the different parameters comprise different communications protocols.

6. The method of claim 1, wherein the specific timeout value is associated with one or more parameters of the test request.

7. The method of claim 1, wherein determining the specific timeout value comprises adding a buffer time to the response time to obtain a base timeout value.

8. The method of claim 7, wherein determining the specific timeout value further comprises applying a complexity weighting to the base timeout value, the complexity weighting associated with a communications protocol.

9. The method of claim 1, further comprising monitoring for an update condition to update the timeout value;
wherein the update condition comprises one or more of:
expiry of a predefined update period; and
detection of a change in a network quality of service parameter.

10. The method of claim 1, further comprising retaining the timeout value when the response to the test request is not received within the timeout value.

11. A device comprising:
a communications interface configured for communications with a target device;
a controller interconnected with the communications interface, the controller configured to:
set a timeout value for retrying communication requests during the communications with the target device;
send a test request to the target device;
measure a response time between the test request and a response to the test request received from the target device;
determine a specific timeout value for the target device based on the response time; and
update the timeout value with the specific timeout value for the target device and continue the communications with the specific timeout value configured for retrying communication requests for the target device.

12. The device of claim 11, wherein to send the test request, the controller is configured to:
send a plurality of test requests and receiving a plurality of responses at respective response times; and
select a slowest response time of the respective response times for determining the specific timeout value.

13. The device of claim 12, wherein each test request of the plurality of test requests includes different parameters.

14. The device of claim 13, wherein the different parameters comprise a marked priority level and an unmarked priority level.

15. The device of claim 13, wherein the different parameters comprise different communications protocols.

16. The device of claim 11, wherein the specific timeout value is associated with one or more parameters of the test request.

17. The device of claim 11, wherein to determine the specific timeout value, the controller is configured to add a buffer time to the response time to obtain a base timeout value.

18. The device of claim 17, wherein to determine the specific timeout value, the controller is further configured to apply a complexity weighting to the base timeout value, the complexity weighting associated with a communications protocol.

19. The device of claim 11, wherein the controller is configured to monitor for an update condition to update the timeout value; and
wherein the update condition comprises one or more of:
expiry of a predefined update period; and
detection of a change in a network quality of service parameter.

20. The device of claim 11, wherein the controller is further configured to retain the timeout value when a the response to the test request is not received within the timeout value.

21. A non-transitory machine-readable storage medium storing instructions, which when executed by a computing device cause the computing device to:
set a timeout value for retrying communication requests during a communications session with a target device;
send a test request to the target device;
measure a response time between the test request and a response to the test request received from the target device;
determine a specific timeout value for the target device based on the response time; and
update the timeout value with the specific timeout value for the target device and continue the communications session with the specific timeout value configured for retrying communication requests for the target device.

22. The non-transitory machine-readable storage medium of claim 21, wherein execution of the instructions further cause the computing device to:
send a plurality of test requests and receiving a plurality of responses at respective response times;
select a slowest response time of the respective response times;
add a buffer time to the slowest response time to obtain a base timeout value; and
apply complexity weightings to the base timeout value to obtain specific timeout values for respective communications protocols, the complexity weightings associated with corresponding communications protocols.
